(19) United States
(12) Patent Application Publication
(10) Pub. No.: US 2026/0320379 A1
(43) Pub. Date: Oct. 15, 2026

(54) METHOD AND SYSTEM FOR PREDICTING POLLUTION EMISSION BASED ON MACHINE LEARNING

(71) Applicant: Chinese Academy of Environmental Planning, Beijing (CN)

(72) Inventors: Yuezhi ZHONG, Beijing (CN); Xin ZHANG, Beijing (CN); Lijuan WANG, Beijing (CN); Yanchao WANG, Beijing (CN); Shiyu HOU, Beijing (CN); Qian TANG, Beijing (CN); Yuanzhou DONG, Beijing (CN)

(21) Appl. No.: 19/443,238

(22) Filed: Jan. 8, 2026

(30) Foreign Application Priority Data
Jan. 8, 2025 (CN) 202510028500.4

(51) Int. Cl. G06N 3/08

(52) U.S. Cl. CPC G06N 3/08

(57) ABSTRACT

A method and a system for predicting pollutant emission based on machine learning are provided, which significantly improves accuracy and reliability of predicting pollutant emission. First, the method obtains a target machine learning data with rich prior knowledge, and combines with model enabling definition information to generate a sample learning data for model updating. These sample learning data are used to perform parameter learning on a target machine learning network model, so that an obtained pollutant emission prediction model can predict any input pollutant emission data more accurately, and a corresponding pollutant emission description label and a label-guided knowledge data are generated. This process not only optimizes learning efficiency of the model, but also improves ability of the model to identify and predict a complex pollutant emission pattern, thereby contributing to environmental pollution monitoring, governance, and decision-making.

### CROSS-REFERENCE TO RELATED APPLICATION

This patent application claims the benefit and priority of Chinese Patent Application No. 202510028500.4 filed with the China National Intellectual Property Administration on Jan. 8, 2025, the disclosure of which is incorporated by reference herein in its entirety as part of the application.

### TECHNICAL FIELD

The present disclosure relates to the technical field of machine learning, and in particular, to a method and a system for predicting pollutant emission based on machine learning.

### BACKGROUND

With the rapid development of industrialization and urbanization, a problem of environmental pollution is increasingly serious, and accurate prediction of pollutant emission is very important for environmental protection, policy formulation, and public health. Traditional methods for predicting pollutant emission often rely on a statistical model or a physical model. These methods have limitations in dealing with complex and changeable pollutant emission data, and it is difficult to accurately reflect an actual situation and a future trend of pollutant emission.

In recent years, a machine learning technology has gradually shown great potential in a field of pollutant emission prediction because of powerful data processing and pattern identification capabilities. However, an existing method for predicting pollutant emission based on machine learning still faces some challenges. On the one hand, these methods usually rely on a large number of historical pollutant emission data for model training, but acquisition of historical data often faces many restrictions, and data quality is uneven, which affects prediction accuracy of the model. On the other hand, it is often difficult for a traditional machine learning method to extract key information effectively when dealing with pollutant emission data with complex features and high nonlinearity, which leads to instability of prediction results.

In addition, an existing machine learning model usually only outputs a single pollutant emission value or a simple classification label when predicting pollutant emission, and lacks detailed description and explanatory information about pollutant emission features, which limits a value of the prediction results in practical application. Therefore, how to construct a machine learning prediction method that can make full use of limited data resources, effectively extract pollutant emission features, and provide rich prediction information has become an urgent problem to be solved in the current field of pollutant emission prediction.

### SUMMARY

In view of the foregoing problems, in combination with a first aspect of the present disclosure, an embodiment of the present disclosure provides a method for predicting pollutant emission based on machine learning, where the method includes:
obtaining a target machine learning data of a target machine learning network model, where the target machine learning data includes a template pollutant emission data, a prior pollutant emission description label of a corresponding template pollutant emission data, and a corresponding label-guided knowledge data, and the prior pollutant emission description label of the template pollutant emission data is selected from a plurality of pre-defined pollutant emission description labels;
obtaining model enabling definition information of the target machine learning network model; where the model enabling definition information characterizes performing pollutant emission prediction on an input pollutant emission data based on the plurality of pollutant emission description labels, and generating a pollutant emission description label of the input pollutant emission data and a corresponding label-guided knowledge data;
generating a sample learning data for updating the target machine learning network model according to the model enabling definition information and the target machine learning data, where the template pollutant emission data in the target machine learning data is configured in the sample learning data as the input pollutant emission data; and
performing model parameter learning on the target machine learning network model according to the sample learning data, and using the target machine learning network model which has subjected to the model parameter learning as a pollutant emission prediction model; where the pollutant emission prediction model is used to perform pollutant emission prediction on any input pollutant emission data, and generate a corresponding pollutant emission description label and a label-guided knowledge data.

In a possible implementation of the first aspect, the sample learning data is a pollutant emission data generated by fusing the model enabling definition information and the target machine learning data; the performing model parameter learning on the target machine learning network model according to the sample learning data includes:
performing feature encoding on the sample learning data to generate X encoded feature node data, where X is a positive integer;
based on time series information of the X encoded feature node data, generating a feature to be learned according to the top X-1 encoded feature node data in the X encoded feature node data; and generating an expected output feature corresponding to the feature to be learned according to X-1 encoded feature node data except a first encoded feature node data among the X encoded feature node data;
inferring the encoded feature node data one by one for the feature to be learned through the target machine learning network model to generate an inference result; where the inference result includes X-1 encoded feature node data that have been inferred, and an a-th encoded feature node data in the inference result is inferred based on the top a encoded feature node data in the feature to be learned, where a is a positive integer between 1 and X-1;
calculating an error parameter corresponding to each encoded feature node data in the inference result based on the expected output feature and the inference result, where an error parameter corresponding to the a-th encoded feature node data in the inference result characterizes a loss result between the a-th encoded feature node data in the inference result and the a-th encoded feature node data in the expected output feature;
fusing error parameters corresponding to respective encoded feature node data in the inference result to generate a training error parameter of the target machine learning network model; and
updating neuron weight information of the target machine learning network model according to a training target that minimizes the training error parameter, so as to perform the model parameter learning on the target machine learning network model.

In a possible implementation of the first aspect, the generating a sample learning data for updating the target machine learning network model according to the model enabling definition information and the target machine learning data includes:
fusing the model enabling definition information and the template pollutant emission data in the target machine learning data for outputting as a pollutant emission data to generate a first pollutant emission data;
fusing the prior pollutant emission description label in the target machine learning data and the label-guided knowledge data in the target machine learning data for outputting as a pollutant emission data to generate a second pollutant emission data; and
generating the sample learning data for updating the target machine learning network model according to the first pollutant emission data and the second pollutant emission data.

In a possible implementation of the first aspect, the performing model parameter learning on the target machine learning network model according to the sample learning data includes:
performing pollutant emission prediction on the template pollutant emission data in the target machine learning data based on the first pollutant emission data in the sample learning data through the target machine learning network model to generate a pollutant emission prediction result; where the pollutant emission prediction result includes the generated pollutant emission description label of the corresponding template pollutant emission data and the corresponding label-guided knowledge data; and
updating the neuron weight information of the target machine learning network model based on a loss result between the pollutant emission prediction result and the second pollutant emission data in the sample learning data, so as to perform the model parameter learning on the target machine learning network model.

In a possible implementation of the first aspect, the target machine learning data is a machine learning data obtained from a training data sequence, and a step of generating the training data sequence includes:
obtaining a plurality of machine learning data of the target machine learning network model, where each machine learning data includes one template pollutant emission data and a training supervision data of the corresponding template pollutant emission data, the training supervision data of any one template pollutant emission data includes a prior pollutant emission description label of the corresponding template pollutant emission data and the corresponding label-guided knowledge data, and the prior pollutant emission description label in any one machine learning data is selected from the plurality of pollutant emission description labels;
determining the number of templates of each pollutant emission description label among the plurality of pollutant emission description labels according to the plurality of machine learning data; where the number of templates of any one pollutant emission description label is used to indicate the number of machine learning data in the plurality of machine learning data containing of the any one pollutant emission description label;
based on the number of templates of each pollutant emission description label, determining a marginal pollutant emission description label from the plurality of pollutant emission description labels; wherein the marginal pollutant emission description label is used to indicate a pollutant emission description label corresponding to the number of templates less than a predetermined number;
extracting one or more template pollutant emission data from the template pollutant emission data contained in the machine learning data including the marginal pollutant emission description label;
performing feature derivation on each selected template pollutant emission data, to generate Y iteration pollutant emission data, where Y is a positive integer; one iteration pollutant emission data corresponds to one template pollutant emission data, and there is a consistent pollution feature path between any one iteration pollutant emission data and its corresponding template pollutant emission data;
using the training supervision data of the template pollutant emission data corresponding to each iteration pollutant emission data as the training supervision data of corresponding iteration pollutant emission data;
using each iteration pollutant emission data as an iteration template pollutant emission data, and generating Y iteration machine learning data according to the Y iteration pollutant emission data and corresponding training supervision data; and
generating the training data sequence according to the plurality of machine learning data and the Y iteration machine learning data.

In a possible implementation of the first aspect, the performing feature derivation on each selected template pollutant emission data, to generate Y iteration pollutant emission data, includes:
obtaining a feature derivation request of a feature derivation network, where the feature derivation request characterizes generating iteration pollutant emission data with a consistent pollution feature path for the template pollutant emission data based on input template pollutant emission data and the prior pollutant emission description label;
obtaining one or more derivative sample combination data, where any one derivative sample combination data includes one sample pollutant emission data, a prior pollutant emission description label of the corresponding one sample pollutant emission data, and a pollutant emission data with a consistent pollution feature path with the corresponding one sample pollutant emission data; and
generating the iteration pollutant emission data with the consistent pollution feature path for each selected template pollutant emission data, based on the feature derivation request and the one or more derivative sample combination data through the feature derivation network, and generating the Y iteration pollutant emission data.

In a possible implementation of the first aspect, the generating the iteration pollutant emission data with the consistent pollution feature path for each selected template pollutant emission data, based on the feature derivation request and the one or more derivative sample combination data through the feature derivation network, and generating Y iteration pollutant emission data, includes:
polling each selected template pollutant emission data, and setting a currently polled template pollutant emission data as a current template pollutant emission data;
generating an input pollutant emission data segment according to the current template pollutant emission data and the corresponding prior pollutant emission description label;
integrating the feature derivation request, the one or more derivative sample combination data, and the input pollutant emission data segment generated to generate a derivative learning data corresponding to the current template pollutant emission data;
generating an iteration pollution emission data with a consistent pollutant feature path with the current template pollutant emission data by learning a derivative learning data corresponding to the current template pollutant emission data through the feature derivation network; and
continuing to perform polling until all selected template pollutant emission data are polled to generate the Y iteration pollutant emission data.

In a possible implementation of the first aspect, the generating the iteration pollutant emission data with the consistent pollution feature path for each selected template pollutant emission data, based on the feature derivation request and the one or more derivative sample combination data through the feature derivation network, and generating Y iteration pollutant emission data, includes:
fusing the feature derivation request and the one or more derivative sample combination data to generate a training sample of the feature derivation network;
using each selected template pollutant emission data and a corresponding prior pollutant emission description label, to generate the input pollutant emission data segment corresponding to each template pollutant emission data;
training the feature derivation network based on the training sample to generate a trained feature derivation network; and
generating the iteration pollutant emission data with the consistent pollution feature path for the corresponding template pollutant emission data based on the input pollutant emission data segment corresponding to each template pollutant emission data through the trained feature derivation network, and generating the Y iteration pollutant emission data.

In a possible implementation of the first aspect, the method further includes:
generating candidate pollutant emission data according to the model enabling definition information and the target pollutant emission data after receiving a prediction instruction for the target pollutant emission data, where the target pollutant emission data is configured in the candidate pollutant emission data as the input pollutant emission data; and
performing pollutant emission prediction on the target pollutant emission data based on the candidate pollutant emission data through the pollutant emission prediction model, and generating pollutant emission description label and corresponding label-guided knowledge data of the target pollutant emission data.

In another aspect, an embodiment of the present disclosure further provides a system for predicting the pollutant emission based on the machine learning, including a processor and a machine-readable storage medium, where the machine-readable storage medium is connected with the processor, the machine-readable storage medium is configured to store programs, instructions or codes, and the processor is configured to execute the programs, instructions or codes in the machine-readable storage medium to implement the forgoing method.

Based on the foregoing aspects, the embodiment of the present disclosure significantly improves accuracy and reliability of predicting pollutant emission. First, the method obtains a target machine learning data with rich prior knowledge, and combines with model enabling definition information to generate a sample learning data for model updating. These sample data are used to perform parameter learning on a target machine learning network model, so that an obtained pollutant emission prediction model can predict any input pollutant emission data more accurately, and a corresponding pollutant emission description label and a label-guided knowledge data are generated. This process not only optimizes learning efficiency of the model, but also improves ability of the model to identify and predict a complex pollutant emission pattern, thereby contributing to environmental pollution monitoring, governance, and decision-making.

### BRIEF DESCRIPTION OF THE DRAWINGS

FIG. 1 is a schematic diagram of an execution flow of a method for predicting pollutant emission based on machine learning according to an embodiment of the present disclosure; and

FIG. 2 is a schematic diagram of a hardware architecture of a system for predicting pollutant emission based on machine learning according to an embodiment of the present disclosure.

### DETAILED DESCRIPTION OF THE EMBODIMENTS

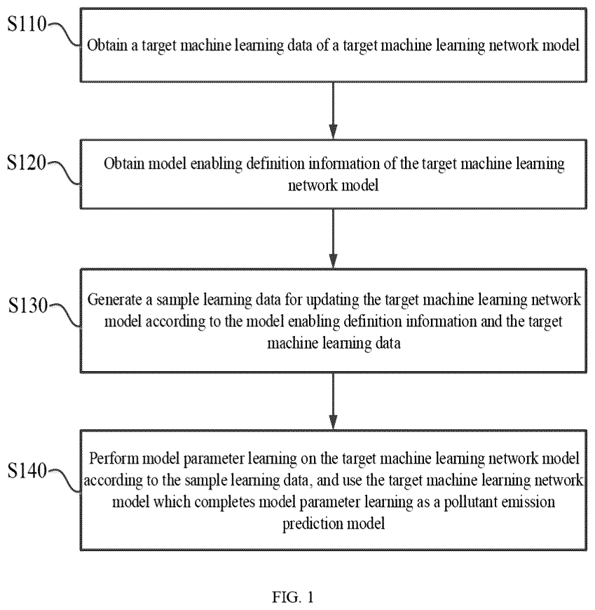

In the following, the present disclosure will be described in detail with reference to the drawings in the specification. FIG. 1 is a schematic diagram of a flow of a method for predicting pollutant emission based on machine learning according to an embodiment of the present disclosure. The method for predicting pollutant emission based on machine learning is described in steps 110-140 in detail below.

In step S110, a target machine learning data of a target machine learning network model is obtained, where the target machine learning data includes a template pollutant emission data, a prior pollutant emission description label of a corresponding template pollutant emission data, and a corresponding label-guided knowledge data, and the prior pollutant emission description label of the template pollutant emission data is selected from a plurality of pre-defined pollutant emission description labels.

In this embodiment, the target machine learning network model aims to accurately analyze and predict air pollutant emission of an enterprise in an industrial park under an environmental monitoring scene of the industrial park. A target machine learning data is a basic sample of model learning.

The template pollutant emission data can be collected from an exhaust emission monitoring device of various enterprises in the industrial park. For example, a concentration of sulfur dioxide (SO₂) is 50 mg/m³, a concentration of nitrogen oxide (NOₓ) is 80 mg/m³, and a concentration of particulate matters (PM) is 30 mg/m³ in the exhaust gas discharged from a chimney of a chemical enterprise in a specific period of time. These data form a template pollutant emission data sample.

A prior pollutant emission description label is selected from a number of complex pre-defined pollutant emission description labels. These pollutant emission description labels are not only simply classified according to the concentration of pollutants, but also involve many factors such as nature of emission sources and a potential impact of emission laws on the environment. For example, for the exhaust emission of the foregoing chemical enterprise, the prior pollutant emission description label may be of “high-concentration compound exhaust emission from a chemical enterprise—great potential environmental harm—short-term fluctuation type”. This label indicates that the emission source is from a chemical enterprise, and the concentration of various pollutants in the exhaust gas is high. Due to the types and concentrations of discharged pollutants, there is a great potential harm to the environment, and the emission situation fluctuates in a short period of time, which may be related to an intermittent production process of an enterprise.

The corresponding label-guided knowledge data is the auxiliary information related to the prior pollutant emission description label. For example, a relationship between a production process of a chemical enterprise and the production of pollutants, a historical change data of the surrounding environment under similar emission conditions (such as the damage of nearby vegetation, the long-term change trend of air quality, and the like), the existing measures taken by the enterprise to control pollution and the effect assessment, and the like, may be included. These label-guided knowledge data helps the model to understand the meaning behind the prior pollutant emission description labels more deeply, thereby performing learning and prediction better.

By collecting many such template pollutant emission data, the corresponding prior pollutant emission description label, and the label-guided knowledge data, the target machine learning data of the target machine learning network model is formed, and each set of data therein is a detailed record and interpretation of different pollutant emission situations in the industrial park, thereby providing rich materials for subsequent training and optimization of the model.

In step S120, model enabling definition information of the target machine learning network model is obtained. The model enabling definition information characterizes: performing pollutant emission prediction on an input pollutant emission data based on the plurality of pollutant emission description labels, and generating the pollutant emission description label of the input pollutant emission data and a corresponding label-guided knowledge data.

For example, in an environmental management system of the industrial park, the model enabling definition information of the target machine learning network model specifies how the target machine learning network model processes the input pollutant emission data based on a plurality of complex pollutant emission description labels.

For example, in the industrial park, there are many types of an enterprise, including chemical, machinery manufacturing, and electronic enterprises. The pollutant emission features of each enterprise are different, and the form and the meaning of the pollutant emission data are also very complex. The model enabling definition information is used to guide the target machine learning network model on how to perform pollutant emission prediction in the face of pollutant emission data of different types of an enterprise.

For the exhaust emission data collected from various enterprises (this is an input pollutant emission data), the model enabling definition information requires the model to perform comprehensive analysis according to a plurality of pre-defined pollutant emission description labels. These labels may cover multi-dimensional information ranging from the types, concentrations, and emission rates of pollutants, to a time rule of emission (for example, whether emission is intermittent, whether the emission is related to production shifts, and the like), and further to a potential impact of emission on different surrounding environmental areas (for example, residential areas, farmlands, places near water bodies, and the like).

Using a chemical enterprise as an example, the model enabling definition information guides the model to take into account all types of complex pollutants (such as volatile organic compounds, heavy metals, and the like) produced in a chemical production process, as well as diffusion laws and environmental impacts of the pollutants under different meteorological conditions (such as a wind direction, a wind speed, a temperature, a humidity, and the like) after receiving the exhaust emission data of the enterprise. At the same time, for exhaust emission from a machinery manufacturing enterprise, the model should pay attention to emission of pollutants such as metal dust and lubricating oil volatiles, and make accurate pollutant emission prediction according to the pollutant emission description label in combination with factors such as the construction scale and device operation status of the enterprise.

When performing pollutant emission prediction, the model also needs to generate a pollutant emission description label of the input pollutant emission data and a corresponding label-guided knowledge data. For example, for the exhaust emission data of a machinery manufacturing enterprise, after model analysis, the pollutant emission description label that may be generated may be of “medium-concentration dust and volatile organic compound emission from a machinery manufacturing enterprise—local environmental impact—stable type”. The corresponding label-guided knowledge data may include a wind direction frequency map of an area where the enterprise is located, the historical data comparison of surrounding air quality monitoring stations, maintenance records and effect analysis of environmental protection device in the enterprise, and the like. These generated labels and knowledge data can provide more detailed and targeted decision-making basis for the environmental management department of the industrial park, and help the department to better supervise the pollutant emission behavior of an enterprise and formulate more reasonable environmental protection policies.

In step S130, a sample learning data for updating the target machine learning network model is generated according to the model enabling definition information and the target machine learning data, where the template pollutant emission data in the target machine learning data is configured in the sample learning data as the input pollutant emission data.

It is assumed that the target machine learning data of the target machine learning network model has been obtained, in which the template pollutant emission data comes from actual monitoring of different enterprises in the industrial park. For example, there is exhaust emission data of an electronic enterprise, which contains information such as the concentration of fluoride of 10 mg/m³ and the concentration of ammonia of 5 mg/m³. This is a template pollutant emission data of the target machine learning data. The corresponding prior pollutant emission description label is of “low-concentration special gas emission from an electronic enterprise—specific area impact—stable type”. The label-guided knowledge data includes the types of chemical agents used in the production process of the enterprise and the distribution of surrounding environment sensitive areas (for example, a nearby high-precision electronic device production workshop is sensitive to the gas).

The model enabling definition information requires that the input pollutant emission data be processed in a specific manner to generate information needed for pollutant emission prediction. According to these requirements, the model enabling definition information is fused with the template pollutant emission data in the target machine learning data. For example, the model enabling definition information specifies a weight distribution method for different types of pollutants (for example, the weight of fluoride in a specific environmental impact assessment is 0.3, and the weight of ammonia in the specific environmental impact assessment is 0.2). In this way, the exhaust emission data of electronic enterprises are fused with the model enabling definition information to generate the first pollutant emission data. This data fuses the requirements of the model for data processing and the actual pollutant emission data. This is a standardized data form.

Then, the prior pollutant emission description label and the label-guided knowledge data in the target machine learning data are fused for outputting as a pollutant emission data to generate a second pollutant emission data. For the example of the foregoing electronic enterprise, the “low-concentration special gas emission from an electronic enterprise—specific area impact—stable type” in the prior pollutant emission description label is integrated with the information such as the types of pharmaceutics produced by the enterprise and the distribution of surrounding environment sensitive areas in the label-guided knowledge data to form a second pollutant emission data containing more semantic information.

Finally, according to the first pollutant emission data and the second pollutant emission data, a sample learning data for updating the target machine learning network model is generated. The sample learning data is a special data structure that integrates model requirements, actual pollutant emission data, prior labels, and related knowledge data, and can be understood as a customized learning sample for the target machine learning network model, which not only contains an original pollutant emission data feature, but also fuses a processing rule required by the model and prior understanding of the data. In this way, the model can better adapt to the complex pollutant emission situation in the industrial park in the subsequent learning process and improve accuracy of pollutant emission prediction for different enterprises.

In step S140, model parameter learning is performed on the target machine learning network model according to the sample learning data, and the target machine learning network model which has subjected to the model parameter learning is used as a pollutant emission prediction model. The pollutant emission prediction model is used to perform pollutant emission prediction on any input pollutant emission data, and generate a corresponding pollutant emission description label and a label-guided knowledge data.

The sample learning data that is generated before is used as an example, which contains all types of fused information. First, feature encoding is performed on the sample learning data. Assuming that the sample learning data is about the pollutant emission from a chemical enterprise, after performing feature encoding, X encoded feature node data are generated. For example, the information such as concentrations of different pollutants, emission rates, and emission time in the exhaust gas of a chemical enterprise is encoded into a series of feature node data. If X=5, these five encoded feature node data may represent a feature of a sulfur dioxide concentration, a feature of a nitrogen oxide emission rate, a feature of an emission time period, a feature of the impact of meteorological conditions (such as a wind direction) on emission, and a feature of the relationship between the production load and the emission of an enterprise.

Based on the time series information of the X encoded feature node data, a feature to be learned is generated according to the top X-1 encoded feature node data. For example, for the foregoing five encoded feature node data, the feature to be learned is constructed according to the first four data (that is, the feature of a sulfur dioxide concentration, the feature of a nitrogen oxide emission rate, the feature of an emission time period, and the feature of the impact of meteorological conditions on emission). At the same time, according to X-1 encoded feature node data except a first encoded feature node data, an expected output feature corresponding to the feature to be learned is generated. That is to say, the expected output feature is constructed according to the last four feature node data (the feature of a nitrogen oxide emission rate, the feature of an emission time period, the feature of the impact of meteorological conditions on emission, and the feature of the relationship between the production load and the emission of an enterprise).

Then, the encoded feature node data is inferred one by one for the feature to be learned through the target machine learning network model. For the first encoded feature node data (the feature of the sulfur dioxide concentration), the model performs derivation according to its own network structure and initial parameters to obtain a preliminary result. Then, based on the preliminary result and the next encoded feature node data (the feature of the nitrogen oxide emission rate), derivation is performed again to obtain an inference result of the second encoded feature node data. And then derivation is repeated in a same manner to generate the inference result finally. The inference result includes X-1 encoded feature node data that have been inferred, and an a-th encoded feature node data is inferred based on the top a encoded feature node data in the feature to be learned (where a is a positive integer between 1 and X-1).

An error parameter corresponding to each encoded feature node data in the inference result is calculated based on the expected output feature and the inference result. For example, the second encoded feature node data (the feature of the nitrogen oxide emission rate) in the inference result is compared with the corresponding data in the expected output feature, to calculate the loss result between the second encoded feature node data and the corresponding data in the expected output feature. The loss result is the error parameter corresponding to the second encoded feature node data.

Error parameters corresponding to respective encoded feature node data in the inference result are fused to generate a training error parameter of the target machine learning network model. The training error parameter comprehensively reflects an overall difference between the model inference result and the expected output feature.

Neuron weight information of the target machine learning network model is updated according to a training target that minimizes the training error parameter. For example, if a neuron is found to have a large error in the inference process of the feature of the nitrogen oxide emission rate, a weight related to the neuron is adjusted, so that the model can be inferred more accurately in the next processing process of similar data. By continuously processing the sample learning data in this way, the parameter of the model is gradually adjusted, and finally the target machine learning network model that has subjected to the model parameter learning is used as the pollutant emission prediction model. The pollutant emission prediction model can perform pollutant emission prediction on any input pollutant emission data in the industrial park, and generate the corresponding pollutant emission description label and the label-guided knowledge data. For example, for the newly input exhaust emission data of a machinery manufacturing enterprise, the model can accurately predict that the pollutant emission description label is of “medium-concentration dust and volatile organic compound emission from a machinery manufacturing enterprise—local environmental impact—stable type”, and generate the label-guided knowledge data including the changing trend of air quality around the enterprise and the potential impact assessment on the health of nearby residents, thereby providing a strong decision support for the environmental management of the industrial park.

The pollutant emission prediction model plays an important role in the daily environmental management of the industrial park. For example, after receiving a prediction instruction for the target pollutant emission data of a newly settled enterprise (assumed to be a small metal processing enterprise), an environmental monitoring platform may generate candidate pollutant emission data according to the previous model enabling definition information and the target pollutant emission data. The target pollutant emission data includes information such as the concentration of metal dust of 20 mg/m³ and the concentration of volatile organic compounds of 15 mg/m³ in the exhaust gas discharged from the chimney of the enterprise. These data are configured in the candidate pollutant emission data as the input pollutant emission data.

Then, pollutant emission prediction is performed on the target pollutant emission data based on the candidate pollutant emission data through the trained pollutant emission prediction model. After complex calculation and analysis, the model generates the pollutant emission description label of the target pollutant emission data, which may be of “medium-concentration compound pollutant emission from a small metal processing enterprise—local environmental risk—fluctuation type”, and generates the corresponding label-guided knowledge data, such as the analysis of impact of wind direction and wind speed changes in the area where the enterprise is located on pollutant diffusion, possible cross-pollution risk assessment of other surrounding enterprises, and suggestions on environmental protection measures that the enterprise should take.

These prediction results can help the management department of the industrial park to know the pollutant emission of the newly settled enterprises in time, formulate corresponding environmental management policies in advance, ensure the overall environmental quality of the industrial park, and protect health and safety of the surrounding residents and the ecological environment. At the same time, as pollutant emission data of more and more enterprises are continuously input into the model for prediction, the model can also be continuously self-optimized and updated to improve accuracy and reliability of predicting pollutant emission for various enterprises in the industrial park.

Based on the foregoing steps, the embodiment of the present disclosure significantly improves accuracy and reliability of predicting pollutant emission. First, the method obtains a target machine learning data with rich prior knowledge, and combines with model enabling definition information to generate a sample learning data for model updating. These sample data are used to perform parameter learning on a target machine learning network model, so that an obtained pollutant emission prediction model can predict any input pollutant emission data more accurately, and a corresponding pollutant emission description label and a label-guided knowledge data are generated. This process not only optimizes learning efficiency of the model, but also improves ability of the model to identify and predict a complex pollutant emission pattern, thereby contributing to environmental pollution monitoring, governance, and decision-making.

In a possible implementation, the sample learning data is a pollutant emission data generated by fusing the model enabling definition information and the target machine learning data. Step S140 includes steps S141-S146.

In step S141, feature encoding is performed on the sample learning data to generate X encoded feature node data, where X is a positive integer.

In this embodiment, for example, there is a large chemical enterprise in the industrial park, and its pollutant emission data contains various complex information. The sample learning data may integrate various information such as concentrations of various pollutants, an emission rate, the emission time, meteorological conditions, and the like. When performing feature encoding, if X is 5, the five encoded feature node data may correspond to different feature aspects, respectively. The first encoded feature node data may be about the feature of the concentration of sulfur dioxide (SO₂) that is a main pollutant, which accurately records the concentration value of SO₂ discharged by the enterprise in a specific time period. The second encoded feature node data may be about the feature of the emission rate of nitrogen oxides (NOₓ), which reflects the NOₓ emission amount per unit time in detail. A third encoded feature node data is about the feature of the emission time period, which makes it clear whether emission occurs during the daytime production peak period or the nighttime low-load period. A fourth encoded feature node data is about the feature of the impact of the wind direction on emission diffusion in meteorological conditions, which considers that different wind directions may lead to great differences in the diffusion path and range of pollutants in the industrial park. A fifth encoded feature node data is about the feature of the relationship between the enterprise production load and the emission, which reflects the relationship between the enterprise production task volume and the pollutant emission amount.

In step S142, based on time series information of the X encoded feature node data, a feature to be learned is generated according to the top X-1 encoded feature node data in the X encoded feature node data; and an expected output feature corresponding to the feature to be learned is generated according to X-1 encoded feature node data except the first encoded feature node data among the X encoded feature node data.

For the example of the foregoing chemical enterprise, the feature to be learned is constructed according to the first four encoded feature node data (the feature of the SO₂ concentration, the feature of the NOₓ emission rate, the feature of the emission time period, and the feature of the impact of the wind direction on emission diffusion). The feature to be learned comprehensively covers the main pollutant-emission-related factors except the relationship between the production load and the emission, forming a feature combination with specific time series logic. At the same time, according to X-1 encoded feature node data except the first encoded feature node data, the expected output feature corresponding to the feature to be learned is generated. That is, an expected output feature is constructed according to the feature of the NOₓ emission rate, the feature of emission time period, the feature of the impact of the wind direction on emission diffusion, and the feature of the relationship between the enterprise production load and the emission. The expected output feature is the result that the model should output in an ideal situation, which has a close logical connection with the feature to be learned and is determined based on the in-depth understanding of the pollutant emission law and the influencing factor of a chemical enterprise.

In step S143, the encoded feature node data is inferred one by one for the feature to be learned through the target machine learning network model to generate an inference result. The inference result includes X-1 encoded feature node data that have been inferred, and an a-th encoded feature node data in the inference result is inferred based on the top a encoded feature node data in the feature to be learned, where a is a positive integer between 1 and X-1.

In this process, the target machine learning network model starts from the first encoded feature node data of the feature to be learned. For the first encoded feature node data (the feature of the SO₂ concentration), the target machine learning network model performs processing according to its existing network structure and initial parameters, and a preliminary inference result is obtained. Then, in combination with the second encoded feature node data (the feature of the NOₓ emission rate), the model performs inference again, and the inference result of the second encoded feature node data based on the top two encoded feature node data is obtained. In this way, the subsequent encoded feature node data are combined to perform inference, and finally the inference result is generated. The inference result contains X-1 encoded feature node data, and the a-th encoded feature node data in the inference result is inferred based on the top a encoded feature node data in the feature to be learned. For example, when a is 3, the third encoded feature node data in the inference result is obtained by integrating the top three encoded feature node data (the feature of the SO₂ concentration, the feature of the NOₓ emission rate, and the feature of the emission time period) in the feature to be learned, which reflects the model inference result under the joint action of the three factors.

In step S144, an error parameter corresponding to each encoded feature node data in the inference result is calculated based on the expected output feature and the inference result, where an error parameter corresponding to the a-th encoded feature node data in the inference result characterizes a loss result between the a-th encoded feature node data in the inference result and the a-th encoded feature node data in the expected output feature.

Taking the chemical enterprise as an example again, the second encoded feature node data (the feature of the NOₓ emission rate) in the inference result is compared with the corresponding data in the expected output feature. Assuming that the NOₓ emission rate in the inference result is 100 kg/h and the NOₓ emission rate in the expected output feature is 120 kg/h, the difference (20 kg/h) between the NOₓ emission rate in the inference result and the NOₓ emission rate in the expected output feature is the error parameter corresponding to the encoded feature node data. The error parameter characterizes the loss result between the encoded feature node data in the inference result and the corresponding data in the expected output feature, which intuitively reflects accuracy of inference of the model on the feature node.

In step S145, error parameters corresponding to respective encoded feature node data in the inference result are fused to generate a training error parameter of the target machine learning network model.

The error parameters corresponding to the five encoded feature node data of the foregoing chemical enterprise are combined by a specific fusion method (such as weighted summation or root mean square calculation). The fusion method comprehensively takes into account the error of each encoded feature node data, and forms a training error parameter that fully reflects an overall difference between the model inference result and the expected output feature.

In step S146, neuron weight information of the target machine learning network model is updated according to a training target that minimizes the training error parameter, so as to perform model parameter learning on the target machine learning network model.

For example, in an example of the chemical enterprise, if a neuron is found to have a large error in the inference process of the feature of the NOₓ emission rate, it indicates that a weight of the neuron may need to be adjusted. By analyzing the training error parameter, the model can determine which neurons contribute more to the error, and then adjust the weights of these neurons. For example, if the correlation weight between a neuron and the feature of the NOₓ emission rate is too large, and leads to more deviations of the inference result of the model on the feature from the expected output feature, the weight of the neuron should be appropriately reduced. By constantly adjusting the weight information of the neuron in this way, the target machine learning network model can gradually improve processing ability of sample learning data, and then improve accuracy of pollutant emission prediction of an enterprise in the industrial park. In the environmental management system of the whole industrial park, the model parameter learning process based on sample learning data helps to construct an accurate and reliable pollutant emission prediction model, which provides a strong technical support for environmental supervision, pollution control of an enterprise and overall environmental protection of the industrial park.

In a possible implementation, step S130 includes steps S131-133.

In step S131, the model enabling definition information and the template pollutant emission data in the target machine learning data are fused for outputting as a pollutant emission data to generate a first pollutant emission data.

In step S132, the prior pollutant emission description label in the target machine learning data and the label-guided knowledge data in the target machine learning data are fused for outputting as a pollutant emission data to generate a second pollutant emission data.

In step S133, a sample learning data for updating the target machine learning network model is updated according to the first pollutant emission data and the second pollutant emission data.

In a possible implementation, Step S140 may further include the following steps:
performing pollutant emission prediction on the template pollutant emission data in the target machine learning data based on the first pollutant emission data in the sample learning data through the target machine learning network model to generate a pollutant emission prediction result; where the pollutant emission prediction result includes the generated pollutant emission description label of the corresponding template pollutant emission data and the corresponding label-guided knowledge data;
updating the neuron weight information of the target machine learning network model based on a loss result between the pollutant emission prediction result and the second pollutant emission data in the sample learning data, so as to perform model parameter learning on the target machine learning network model.

In this embodiment, taking a large iron and steel enterprise in an industrial park as an example, the model enabling definition information includes rules and requirements for processing of various types of pollutant emission data, such as a principle of weight distribution for different pollutants, importance consideration of different emission time periods, and a calculation method of the impact of meteorological conditions on pollution diffusion. The template pollutant emission data of the iron and steel enterprise contains rich information. For example, a concentration of particulate matters (PM) discharged from the chimney is 80 mg/m³, a concentration of sulfur dioxide (SO₂) discharged from the chimney is 150 mg/m³, and a concentration of nitrogen oxide (NOₓ) discharged from the chimney is 200 mg/m³ in a specific period of time. At the same time, there are also relevant data such as an emission flow rate and a temperature. In a fusion process, for example, according to the principle of weight distribution in the model enabling definition information, the weight of SO₂ concentration in the overall pollution assessment is 0.3, the weight of NOₓ concentration in the overall pollution assessment is 0.4, the weight of PM concentration in the overall pollution assessment is 0.2, and the weight of other factors in the overall pollution assessment is 0.1. These weights are calculated and fused with the actual pollutant emission data of the iron and steel enterprise. Such fusion is not a simple addition of values, but according to a pre-determined complex calculation rule, takes into full account the relationship between various factors and the comprehensive effect on the environment, and finally generates the first pollutant emission data. The first pollutant emission data is a standardized data form that integrates the model requirements and the actual pollutant emission features, and provides an input data that conforms to the logical structure of the model for subsequent model learning.

Then, the prior pollutant emission description label in the target machine learning data and the label-guided knowledge data in the target machine learning data are fused for outputting as a pollutant emission data to generate a second pollutant emission data. For the foregoing iron and steel enterprise, the prior pollutant emission description label may be of “high-concentration compound pollutant emission of a large iron and steel enterprise—extensive environmental impact—stable type”. The label not only indicates the scale of the enterprise and the concentration type of discharged pollutants, but also implies the range of environmental impact and the stability of emission. The corresponding label-guided knowledge data contains a lot of information, such as the relationship between the production process and the production of pollution in the iron and steel enterprise, that is, which links in an ironsmelting and steelmaking process may produce a lot of SO₂, NOₓ and PM; the surrounding environment of the enterprise, such as the surrounding sensitive areas (such as residential areas, farmlands, water sources, and the like) and the relative position relationship between these surrounding sensitive areas and the enterprise; and pollution control measures taken by the enterprise and the effect assessment, such as the operating efficiency of installed desulfurization, denitrification and dust removal devices, and the actual contribution to pollutant emission reduction. When the prior pollutant emission description label and the label-guided knowledge data are fused, various semantic information in the prior pollutant emission description label should be organically integrated with the specific content in the label-guided knowledge data. For example, the “extensive environmental impact” is combined with the distribution of surrounding sensitive areas, and the “stable” emission is linked with the stable operation of an existing pollution control device of an enterprise. In this way, a second pollutant emission data with rich semantics and actual conditions is constructed.

Then, a sample learning data for updating the target machine learning network model is generated according to the first pollutant emission data and the second pollutant emission data. The sample learning data is a special data structure that integrates the first pollutant emission data and the second pollutant emission data, which not only contains the actual data feature of pollutant emission after being processed according to the model requirements (the first pollutant emission data), but also integrates the prior pollutant emission description label and the related label-guided knowledge data (the second pollutant emission data). This structure enables the sample learning data to provide comprehensive learning information for the target machine learning network model, which not only allows the model to understand the actual numerical value situation of pollutant emission, but also allows the model to understand the meaning behind these numerical values and related environmental impact factors, thereby laying a foundation for accurate learning and parameter updating of the model.

In terms of performing model parameter learning on the target machine learning network model according to the sample learning data, pollutant emission prediction is performed on the template pollutant emission data in the target machine learning data based on the first pollutant emission data in the sample learning data through the target machine learning network model to generate a pollutant emission prediction result. Still taking the iron and steel enterprise as an example, the target machine learning network model uses the first pollutant emission data as input. The first pollutant emission data contains the relevant information by fusing pollutant emission feature of the iron and steel enterprise and requirements of the model. The target machine learning network model analyzes and predicts the template pollutant emission data of the iron and steel enterprises according to its network structure and existing parameters. For example, when the model processes the data such as the concentration of pollutants, the flow rate, and the temperature in the iron and steel enterprise, the model combines its own learned pollutant emission laws and related knowledge to generate the pollutant emission prediction result. This pollutant emission prediction result includes the generated pollutant emission description label of the corresponding template pollutant emission data and the corresponding label-guided knowledge data. It is assumed that the generated pollutant emission description label is of “high-concentration compound pollutant emission from a large iron and steel enterprise—serious environmental impact—stable type”. The “serious environmental impact” here is the more accurate environmental impact assessment obtained by the model based on the analysis of the concentration of pollutants and surrounding environment sensitive areas. The corresponding label-guided knowledge data may include more detailed prediction of surrounding environment changes, such as the deterioration trend of surrounding air quality, the increased potential pollution risk of water quality to nearby water sources, and the elevated magnitude of the health risk to surrounding residents in the coming period under the current pollutant emission level.

Finally, the neuron weight information of the target machine learning network model is updated based on a loss result between the pollutant emission prediction result and the second pollutant emission data in the sample learning data, so as to perform model parameter learning on the target machine learning network model. The pollutant emission prediction result of the foregoing iron and steel enterprise is compared with the second pollutant emission data, and the loss result between the pollutant emission prediction result and the second pollutant emission data is calculated. For example, in terms of the pollutant emission description label, there is semantic difference between “serious environmental impact” and “extensive environmental impact” in the second pollutant emission data. The difference reflects the deviation between model prediction and prior knowledge. In terms of the label-guided knowledge data, the predicted deterioration trend of surrounding air quality, the increased potential pollution risk of water quality in water sources may also deviate from the actual situation in the second pollutant emission data (such as the result obtained from historical data and actual monitoring) to varying degrees. These deviations are quantified by a specific loss function, and an overall loss result is obtained. According to this loss result, which neurons in the model contribute more to the deviation in the prediction process is analyzed. For example, if it is found that neurons related to analysis of the concentration of pollutants play a key role in predicting “serious environmental impact”, and the prediction result significantly deviates from the actual situation, the weight information of these neurons is adjusted. By constantly updating the weight information of the neurons according to the loss result, the target machine learning network model can gradually optimize its own parameters and improve accuracy of pollutant emission prediction of an enterprise in the industrial park, thereby better adapting to the complex environmental management needs of the industrial park and providing a strong technical support for environmental protection and sustainable development of the industrial park.

In a possible implementation, the target machine learning data is a machine learning data obtained from a training data sequence, and a step of generating the training data sequence includes steps A110-A180.

In step A110, a plurality of machine learning data of the target machine learning network model are obtained, where each machine learning data includes one template pollutant emission data and a training supervision data corresponding to the template pollutant emission data. The training supervision data of any one template pollutant emission data includes the prior pollutant emission description label of the corresponding template pollutant emission data and the corresponding label-guided knowledge data, and the prior pollutant emission description label in any one machine learning data is selected from the plurality of pollutant emission description labels.

In this embodiment, in the industrial park, different enterprises have different pollutant emission situations, and these situations are collected and sorted as machine learning data. A machine learning data includes a template pollutant emission data and a corresponding training supervision data. For example, for a chemical enterprise, the template pollutant emission data may be information of various pollutants discharged from a chimney in a specific time period. For example, a concentration of sulfur dioxide (SO₂) is 50 mg/m³, a concentration of nitrogen oxide (NOₓ) is 80 mg/m³, and a concentration of particulate matters (PM) is 30 mg/m³. The training supervision data of the corresponding template pollutant emission data includes the prior pollutant emission description label and the label-guided knowledge data. The prior pollutant emission description label may be of “medium-concentration compound pollutant emission from a chemical enterprise—local environmental impact13 fluctuation type”. The label describes information such as the enterprise type, the pollutant emission concentration level, the range of the environmental impact, and stability of emission in detail. The label-guided knowledge data may include a link related to the generation of pollution in the production process of the chemical enterprise, such as a large number of SO₂ produced by a specific chemical reaction, and relevant information of the surrounding environment, such as farmland nearby and the impact of a wind direction on the diffusion direction of pollutants. The prior pollutant emission description label in each machine learning data is selected from a plurality of pollutant emission description labels. The plurality of pollutant emission description labels cover the classified description of various possible pollutant emission situations in the industrial park.

In step A120, the number of templates of each pollutant emission description label among the plurality of pollutant emission description labels is determined according to the plurality of machine learning data. The number of templates of any one pollutant emission description label is used to indicate the number of machine learning data in the plurality of machine learning data containing the any one pollutant emission description label.

After machine learning data of many enterprises in the industrial park are collected, these machine learning data are analyzed and counted. For example, there are a variety of pollutant emission description labels, such as “high-concentration compound pollutant emission from a chemical enterprise—extensive environmental impact—stable type” and “medium-concentration dust and volatile organic compound emission from a machinery manufacturing enterprise—local environmental impact—stable type”. According to statistics, there are 50 groups of machine learning data labeled as “high-concentration compound pollutant emission from a chemical enterprise—extensive environmental impact—stable type”, which is the number of templates of the pollutant emission description label. However, there are only 10 groups of machine learning data labeled as “low-concentration dust emission from a machinery manufacturing enterprise—limited environmental impact—fluctuation type”, which is the number of templates of the corresponding pollutant emission description label. The number of templates of each pollutant emission description label indicates the number of machine learning data containing the pollutant emission description label in the plurality of machine learning data.

In step A130, based on the number of templates of each pollutant emission description label, a marginal pollutant emission description label is determined from the plurality of pollutant emission description labels. The marginal pollutant emission description label is used to indicate the pollutant emission description label corresponding to the number of templates less than a predetermined number.

Assuming that the predetermined number is 20, the pollutant emission description label in which the number of templates is less than 20 is determined as a marginal pollutant emission description labels. For example, because the number of templates of “low-concentration dust emission from a machinery manufacturing enterprise—limited environmental impact—fluctuation type” is 10, which is less than the predetermined number of 20, this is the marginal pollutant emission description label. The machine learning data corresponding to these marginal pollutant emission description labels are relatively few, possibly because such pollutant emission scenarios are relatively special or uncommon in the industrial park.

In step A140, one or more template pollutant emission data are extracted from the template pollutant emission data contained in the machine learning data including the marginal pollutant emission description label.

For “low-concentration dust emission from a machinery manufacturing enterprise—limited environmental impact—fluctuation type” which is determined as the marginal pollutant emission description label, the template pollutant emission data is extracted from the corresponding machine learning data. For example, the dust emission data of a small machinery manufacturing enterprise in a specific time period is extracted from the machine learning data of the small machinery manufacturing enterprise, including data such as the dust concentration of 15 mg/m³ and the emission rate of 2 kg/h.

In step A150, feature derivation is performed on each selected template pollutant emission data, to generate Y iteration pollutant emission data, where Y is a positive integer. An iteration pollutant emission data corresponds to a template pollutant emission data, and there is a consistent pollution feature path between any one iteration pollutant emission data and its corresponding template pollutant emission data.

Taking the dust emission data collected from the machinery manufacturing enterprise as an example, the feature derivation is performed. Assuming that Y is 3, the pollution feature path of the dust emission data is kept unchanged through a specific feature derivation algorithm, which is still the feature derivation related to dust emission. Three iteration pollutant emission data may be generated according to some related factors in the production process of the enterprise, such as operation time of a device and a cleaning frequency of a device. A first iteration pollutant emission data may take into account dust emission after the operation time of the device is prolonged, in which for example, the dust concentration becomes 18 mg/m³, and the emission rate becomes 2.2 kg/h. A second iteration pollutant emission data may be the situation after the cleaning frequency of the device is reduced, in which the dust concentration becomes 20 mg/m³, and the emission rate becomes 2.5 kg/h. A third iteration pollutant emission data may integrate the situation after the operation time of the device is prolonged with the situation after the cleaning frequency of the device is reduced, in which the dust concentration becomes 22 mg/m³ and the emission rate becomes 2.8 kg/h.

In step A160, the training supervision data of the template pollutant emission data corresponding to each iteration pollutant emission data is used as the training supervision data of the corresponding iteration pollutant emission data.

For the three iteration pollutant emission data of the dust emission data of the foregoing machinery manufacturing enterprise, because the training supervision data of the original template pollutant emission data contains the prior pollutant emission description label “low-concentration dust emission from a machinery manufacturing enterprise—limited environmental impact—fluctuation type” and related label-guided knowledge data (such as the distribution of residential areas in the surrounding environment of the enterprise, the impact of the wind direction on dust diffusion, and the like), the corresponding iteration pollutant emission data are also used as these training and supervision data.

In step A170, each iteration pollutant emission data is used as an iteration template pollutant emission data, and generate Y iteration machine learning data according to the Y iteration pollutant emission data and the corresponding training supervision data.

For example, for the generated three iteration pollutant emission data and their corresponding training supervision data, three iteration machine learning data are constructed. Each iteration machine learning data contains an iteration template pollutant emission data and a corresponding training supervision data, which can be understood as the same as the original machine learning data, except that the data here is an iterative version obtained by feature derivation.

In step A180, the training data sequence is generated according to the plurality of machine learning data and the Y iteration machine learning data.

For example, the plurality of the previously collected machine learning data about enterprises in the industrial park are all integrated with the newly generated Y iteration machine learning data to form a complete training data sequence. The training data sequence contains pollutant emission data of various enterprises in the industrial park, the prior pollutant emission description label, the label-guided knowledge data, and iteration data after feature derivation, thereby providing rich and comprehensive data resources for the target machine learning network model, enabling the model to learn the feature of various pollutant emission, improving accuracy and reliability of pollutant emission prediction in the industrial park, helping the environmental management department of the industrial park to better supervise the pollutant emission behavior of an enterprise and protect the environmental quality of the industrial park.

In a possible implementation, step A150 includes steps A151-A153.

In step A151, a feature derivation request of a feature derivation network is obtained, where the feature derivation request characterizes generating iteration pollutant emission data with a consistent pollution feature path for the template pollutant emission data based on the input template pollutant emission data and the prior pollutant emission description label.

In this embodiment, in the industrial park, the feature derivation request has a clear characterization meaning. That is, based on the input template pollutant emission data and the prior pollutant emission description label, the iteration pollutant emission data with the consistent pollution feature path is generated for the template pollutant emission data. Taking a chemical enterprise in an industrial park as an example, the template pollutant emission data contains various pollutant emission information in a specific period of time. For example, a concentration of sulfur dioxide (SO₂) is 50 mg/m³, a concentration of nitrogen oxide (NOₓ) is 80 mg/m³, a concentration of particulate matters (PM) is 30 mg/m³, and the prior pollutant emission description label is of “medium-concentration compound pollutant emission from a chemical enterprise—local environmental impact—fluctuation type”. The feature derivation request is to generate new pollutant emission data according to the template pollutant emission data and the prior pollutant emission description label, and the new pollutant emission data should keep the pollution feature path consistent with the original data (e.g., the template pollutant emission data and the prior pollutant emission description label). This means that the new pollutant emission data is similar to the original data in terms of pollutant types and relevant logical relationships of emission.

In step A152, one or more derivative sample combination data are obtained, where any one derivative sample combination data includes one sample pollutant emission data, a prior pollutant emission description label of the corresponding one sample pollutant emission data, and a pollutant emission data with a consistent pollution feature path with the corresponding one sample pollutant emission data.

For example, for another chemical enterprise (as a sample enterprise), the sample pollutant emission data is as follows: a concentration of sulfur dioxide (SO₂) of 45 mg/m³, a concentration of nitrogen oxide (NOₓ) of 75 mg/m³, a concentration of particulate matters (PM) of 25 mg/m³, the prior pollutant emission description label of “medium-concentration compound pollutant emission from a chemical enterprise—local environmental impact—fluctuation type”, and the pollutant emission data with the consistent pollution feature path with the sample pollutant emission data being possibly emission data in different time periods but with similar production processes and device operating conditions, such as, a concentration of sulfur dioxide (SO₂) of 48 mg/m³, a concentration of nitrogen oxide (NOₓ) of 78 mg/m³, and a concentration of particulate matters (PM) of 28 mg/m³. These derivative sample combination data cover the emission conditions of different chemical enterprises under similar pollution feature paths, which provides more reference basis for subsequent feature derivation.

In step A153, the iteration pollutant emission data with the consistent pollution feature path is generated for each selected template pollutant emission data, based on the feature derivation request and the one or more derivative sample combination data through the feature derivation network, to generate Y iteration pollutant emission data.

In a possible implementation, step A153 may include:
polling each selected template pollutant emission data, and using the currently polled template pollutant emission data as a current template pollutant emission data;
generating an input pollutant emission data segment according to the current template pollutant emission data and the corresponding prior pollutant emission description label;
integrating the feature derivation request, the one or more derivative sample combination data, and the input pollutant emission data segment generated to generate a derivative learning data corresponding to the current template pollutant emission data;
generating an iteration pollutant emission data with a consistent pollution feature path with the current template pollutant emission data by learning a derivative learning data corresponding to the current template pollutant emission data through the feature derivation network; and
continuing to perform polling until each selected template pollutant emission data is polled to generate Y iteration pollutant emission data.

Taking the template pollutant emission data of the chemical enterprise mentioned above as an example, in the polling process, when the template pollutant emission data of the chemical enterprise is polled, the template pollutant emission data becomes the current template pollutant emission data. An input pollutant emission data segment is generated according to the current template pollutant emission data and the corresponding prior pollutant emission description label. For this chemical enterprise, according to its template pollutant emission data (a concentration of SO₂ of 50 mg/m³, a concentration of NOₓ of 80 mg/m³, and a concentration of PM of 30 mg/m³) and a prior pollutant emission description label (“medium concentration compound pollutant emission from a chemical enterprise—local environmental impact—fluctuation type”), an input pollutant emission data segment is generated through a specific algorithm and rule. This data segment may be obtained by performing specific feature extraction and organization on the original template pollutant emission data. For example, the features related to the pollutant emission concentration are mainly extracted, and an input pollutant emission data segment containing information such as a specific pollutant concentration ratio relationship and a total pollution concentration level is formed.

The feature derivation request, one or more derivative sample combination data, and the generated input pollutant emission data segment are integrated to generate derivative learning data corresponding to the current template pollutant emission data. The previously obtained feature derivation request (generating the iteration pollutant emission data with the consistent pollution feature path based on the template pollutant emission data and the prior pollutant emission description label of the chemical enterprise), the derivative sample combination data (such as sample pollutant emission data of other chemical enterprises and relevant information), and the newly generated input pollutant emission data segment are integrated. This integration process is a complex data integration operation. These data needs to be combined according to a specific format and logic. For example, the target requirements in the feature derivation request, the emission data and the label information of different chemical enterprises in the derivative sample combination data, and information such as the feature of the concentration in the input pollutant emission data segment are arranged and combined according to a pre-defined data structure to generate the derivative learning data corresponding to the current template pollutant emission data. The derivative learning data contains rich information, including the target requirements, reference samples, and their own feature data segments, thereby providing comprehensive learning materials for the feature derivation network.

The iteration pollutant emission data with the consistent pollution feature path with the current template pollutant emission data is generated by learning the derivative learning data corresponding to the current template pollutant emission data through the feature derivation network. The feature derivation network performing learning and analysis according to all types of information in derivative learning data. For example, according to the consistency requirement of the pollution feature path in the feature derivation request, referring to the emission situation of similar enterprises in the derivative sample combination data, in combination with the information such as the feature of the concentration in the input pollutant emission data segment, and using the internal algorithm and model structure, the iteration pollutant emission data with the consistent pollution feature path with the current template pollutant emission data is generated. It is assumed that the generated iteration pollutant emission data is as follows: a concentration of sulfur dioxide (SO₂) of 52 mg/m³, a concentration of nitrogen oxide (NOₓ) of 82 mg/m³, and a concentration of particulate matters (PM) of 32 mg/m³ . This data keeps consistent with the original template pollutant emission data in terms of pollutant types and emission logic relationships, but changes in specific concentrations of pollutants, thereby reflecting derivation of pollutant emission data under specific conditions. Polling is continued until each selected template pollutant emission data is polled to generate Y iteration pollutant emission data. For example, if Y=3 iteration pollutant emission data need to be generated, the same operation may be performed on other selected template pollutant emission data (possibly from different enterprises or the same enterprise in different time periods) according to the foregoing polling and generation manner until three such iteration pollutant emission data are generated.

In a possible implementation, step A153 may further include:
fusing the feature derivation request and the one or more derivative sample combination data to generate a training sample of the feature derivation network;
using each selected template pollutant emission data and a corresponding prior pollutant emission description label, to generate the input pollutant emission data segment corresponding to each template pollutant emission data;
training the feature derivation network based on the training sample to generate a trained feature derivation network; and
generating the iteration pollutant emission data with the consistent pollution feature path for the corresponding template pollutant emission data based on the input pollutant emission data segment corresponding to each template pollutant emission data through the trained feature derivation network, to generate Y iteration pollutant emission data.

In another possible implementation, the feature derivation request (generating the iteration pollutant emission data with the consistent pollution feature path based on the template pollutant emission data and the prior pollutant emission description label) and the derivative sample combination data (sample pollutant emission data of a plurality of chemical enterprises and the relevant information) are fused. This fusion process needs to consider how to effectively combine the target information in the feature derivation request with the actual emission data and the label information in the derivative sample combination data. For example, the target requirement in the feature derivation request can be transformed into specific label information, and then arranged and combined with the pollutant emission data of each enterprise in the derivative sample combination data and the prior pollutant emission description label in a specific order to form a training sample of the feature derivation network. This training sample is a data set that integrates the target requirement and the actual reference data, thereby providing a basis for training of the feature derivation network.

Each selected template pollutant emission data and a corresponding prior pollutant emission description label are used, to generate the input pollutant emission data segment corresponding to each template pollutant emission data. For each selected template pollutant emission data (such as the template pollutant emission data of the chemical enterprise mentioned above and the template pollutant emission data of other enterprises), the input pollutant emission data segment is generated according to a specific algorithm in combination with the corresponding prior pollutant emission description label. This process is similar to that mentioned above, which is to perform feature extraction and organization of the template pollutant emission data to form an input pollutant emission data segment containing key pollutant emission feature information.

Based on the training sample, the feature derivation network is trained to generate the trained feature derivation network. The generated training sample is input into the feature derivation network, and the feature derivation network adjusts its own parameters according to the information in the training sample. For example, according to the sample pollutant emission data of different chemical enterprises in the training sample, the prior pollutant emission description label, and the target requirement in the feature derivation request, the feature derivation network constantly adjusts parameters such as a connection weight between neurons through the internal algorithm mechanism, so that the feature derivation network can accurately generate the iteration pollutant emission data with the consistent pollution feature path according to the input template pollutant emission data and its prior pollutant emission description label. After a plurality of training iterations, the feature derivation network gradually optimizes its own performance, and finally generates the trained feature derivation network.

The iteration pollutant emission data with the consistent pollution feature path is generated for the corresponding template pollutant emission data based on the input pollutant emission data segment corresponding to each template pollutant emission data through the trained feature derivation network, and Y iteration pollutant emission data are generated. For each template pollutant emission data, its corresponding input pollutant emission data segment is input into the trained feature derivation network. For example, for the input pollutant emission data segment corresponding to the template pollutant emission data of the chemical enterprise, the trained feature derivation network generates the iteration pollutant emission data with the consistent pollution feature path with the template pollutant emission data of the chemical enterprise according to the feature information in the input pollutant emission data segment, and the parameter and the model structure obtained by self-training. In this way, all the template pollutant emission data that need to generate the iteration pollutant emission data are operated until Y iteration pollutant emission data are generated. These iteration pollutant emission data are of great significance in the environmental management of the industrial park, thereby enriching the types and changes of pollutant emission data, providing more diverse data for the target machine learning network model, improving accuracy and comprehensiveness of the model for predicting pollutant emission in the industrial park, and helping to regulate the pollutant emission behavior of an enterprise more accurately and protect the environmental quality of the industrial park.

In a possible implementation, the method further includes steps S150-S160.

In step S150, candidate pollutant emission data is generated according to the model enabling definition information and the target pollutant emission data after receiving a prediction instruction for the target pollutant emission data, where the target pollutant emission data is configured in the candidate pollutant emission data as the input pollutant emission data.

In step S160, pollutant emission prediction is performed on the target pollutant emission data based on the candidate pollutant emission data through the pollutant emission prediction model, and the pollutant emission description label and the corresponding label-guided knowledge data of the target pollutant emission data are generated.

In this embodiment, for example, there is a new electronic enterprise in an industrial park. The target pollutant emission data of the new electronic enterprise includes various information in exhaust gas emission, such as the concentration of fluoride of 10 mg/m³ and the concentration of ammonia of 5 mg/m³, as well as relevant data such as an emission flow rate and a temperature. The model enabling definition information includes rules and requirements for processing of various types of pollutant emission data, such as a principle of weight distribution for different pollutants, importance consideration of different emission time periods, and a calculation method of the impact of meteorological conditions on pollution diffusion. When generating candidate pollutant emission data, the target pollutant emission data of the electronic enterprise are integrated according to the rules in the model enabling definition information. For example, according to the principle of weight distribution in the model enabling definition information, the weight of fluoride concentration in the overall pollution assessment is 0.3, the weight of ammonia concentration in the overall pollution assessment is 0.2, and the weight of other factors in the overall pollution assessment is 0.5. These weights are calculated and fused with the actual pollutant emission data of the electronic enterprise. Such fusion is not a simple addition of values, but according to a pre-set complex calculation rule, takes into full account the relationship between various factors and the comprehensive effect on the environment impact, and finally generates the candidate pollutant emission data. The candidate pollutant emission data is a standardized data form that integrates the model requirements and the actual pollutant emission features, and provides an input data that conforms to the logical structure of the model for subsequent pollutant emission prediction.

Then, pollutant emission prediction is performed on the target pollutant emission data based on the candidate pollutant emission data through the pollutant emission prediction model, to generate the pollutant emission description label and the corresponding label-guided knowledge data of the target pollutant emission data. The pollutant emission prediction model uses the candidate pollutant emission data as input. The candidate pollutant emission data contains the relevant information that integrates pollutant emission features of the electronic enterprise and the requirements of the model. The model analyzes and predicts the target pollutant emission data of the electronic enterprise according to its own network structure and existing parameters. For example, when the model processes the data such as the concentration of pollutants, the flow rate, and the temperature in the electronic enterprise, the model combines its own learned pollutant emission laws and related knowledge to generate the pollutant emission prediction result. This pollutant emission prediction result includes the generated pollutant emission description label of the corresponding target pollutant emission data and the corresponding label-guided knowledge data. It is assumed that the generated pollutant emission description label is of “low-concentration special gas emission from an electronic enterprise—specific area impact—stable type”. The “specific area impact” here is the environmental impact assessment obtained by the model based on the analysis of the concentration of pollutants and surrounding environment sensitive areas (for example, a nearby high-precision electronic device production workshop is sensitive to the gas). The corresponding label-guided knowledge data may include more detailed prediction of surrounding environment changes, such as the changing trend of surrounding air quality in the coming period under the current pollutant emission level, the potential impact risk on the product quality of the nearby high-precision electronic device production workshop, and the measures and suggestions that the enterprise may take to reduce pollutant emission. These prediction results can provide valuable information for the management department of the industrial park, help the management department to know the pollutant emission of the newly settled enterprises in time, formulate corresponding environmental management policies in advance, ensure the overall environmental quality of the industrial park, and protect health and safety of the surrounding residents and the ecological environment.

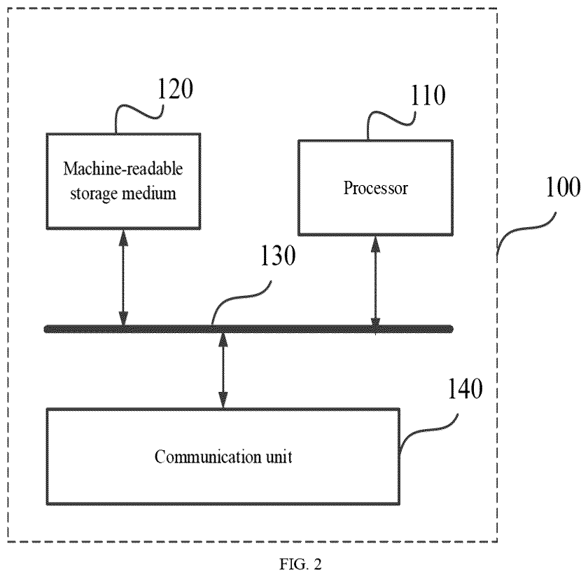

FIG. 2 shows a schematic diagram of a hardware architecture of a system for predicting pollutant emission 100 based on machine learning which is used to implement the foregoing method for predicting pollutant emission based on machine learning according to an embodiment of the present disclosure. As shown in FIG. 2, the system for predicting pollutant emission 100 based on machine learning may include a processor 110, a machine-readable storage medium 120, a bus 130, and a communication unit 140.

The machine-readable storage medium 120 may store data and/or instructions. In some embodiments, the machine-readable storage medium 120 may store data obtained from an external terminal. In some embodiments, the machine-readable storage medium 120 may store data and/or instructions used by the system for predicting pollutant emission 100 based on machine learning to perform or use to complete the exemplary method described in the present disclosure.

In a specific implementation process, one or more processors 110 execute computer-executable instructions stored in the machine-readable storage medium 120, so that the processor 110 can execute the method for predicting pollutant emission based on machine learning as described in the foregoing method embodiment. The processor 110, the machine-readable storage medium 120, and the communication unit 140 are connected through the bus 130. The processor 110 may be configured to control transmitting and receiving operations of the communication unit 140.

For the specific implementation process of the processor 110, refer to each method embodiment executed by the foregoing system for predicting pollutant emission 100 based on machine learning. An implementation principle and a technical effect are similar, which will not be described in detail in this embodiment here.

In addition, an embodiment of the present disclosure further provides a non-transitory readable storage medium. Computer-executable instructions are preset in the non-transitory readable storage medium. The processor, when executing the computer-executable instructions, implements the method for predicting pollutant emission based on machine learning.

It should be noted that, in order to simplify a description of the present disclosure and help to understand one or more embodiments of the present disclosure, in the foregoing description of the embodiment of the present disclosure, various features are sometimes combined into one embodiment, the drawings or the description thereof.

1. A method for predicting pollutant emission based on machine learning, wherein the method comprises:
obtaining a target machine learning data of a target machine learning network model, wherein the target machine learning data comprises a template pollutant emission data, a prior pollutant emission description label of a corresponding template pollutant emission data, and a corresponding label-guided knowledge data, and the prior pollutant emission description label of the template pollutant emission data is selected from a plurality of pre-defined pollutant emission description labels;
obtaining model enabling definition information of the target machine learning network model; wherein the model enabling definition information characterizes performing pollutant emission prediction on an input pollutant emission data based on the plurality of pollutant emission description labels, and generating a pollutant emission description label of the input pollutant emission data and a corresponding label-guided knowledge data;
generating a sample learning data for updating the target machine learning network model according to the model enabling definition information and the target machine learning data, wherein the template pollutant emission data in the target machine learning data is configured in the sample learning data as the input pollutant emission data; and
performing model parameter learning on the target machine learning network model according to the sample learning data, and using the target machine learning network model which has subjected to the model parameter learning as a pollutant emission prediction model; wherein the pollutant emission prediction model is used to perform pollutant emission prediction on any input pollutant emission data, and generate a corresponding pollutant emission description label and a label-guided knowledge data.

2. The method for predicting the pollutant emission based on the machine learning according to claim 1, wherein the sample learning data is one pollutant emission data generated by fusing the model enabling definition information and the target machine learning data; the performing the model parameter learning on the target machine learning network model according to the sample learning data comprises:
performing feature encoding on the sample learning data to generate X encoded feature node data, wherein X is a positive integer;
based on time series information of the X encoded feature node data, generating a feature to be learned according to a top X-1 encoded feature node data in the X encoded feature node data; and generating an expected output feature corresponding to the feature to be learned according to X-1 encoded feature node data except a first encoded feature node data among the X encoded feature node data;
inferring the encoded feature node data one by one for the feature to be learned through the target machine learning network model to generate an inference result;
wherein the inference result comprises X-1 encoded feature node data that have been inferred, and an a-th encoded feature node data in the inference result is inferred based on a top a encoded feature node data in the feature to be learned, where a is a positive integer between 1 and X-1;
calculating an error parameter corresponding to each encoded feature node data in the inference result based on the expected output feature and the inference result, wherein an error parameter corresponding to the a-th encoded feature node data in the inference result characterizes a loss result between the a-th encoded feature node data in the inference result and the a-th encoded feature node data in the expected output feature;
fusing error parameters corresponding to respective encoded feature node data in the inference result to generate a training error parameter of the target machine learning network model; and
updating neuron weight information of the target machine learning network model according to a training target that minimizes the training error parameter, so as to perform the model parameter learning on the target machine learning network model.

3. The method for predicting the pollutant emission based on the machine learning according to claim 1, wherein the generating a sample learning data for updating the target machine learning network model according to the model enabling definition information and the target machine learning data comprises:
fusing the model enabling definition information and the template pollutant emission data in the target machine learning data for outputting as one pollutant emission data to generate a first pollutant emission data;
fusing the prior pollutant emission description label in the target machine learning data and the label-guided knowledge data in the target machine learning data for outputting as one pollutant emission data to generate a second pollutant emission data; and
generating the sample learning data for updating the target machine learning network model according to the first pollutant emission data and the second pollutant emission data.

4. The method for predicting the pollutant emission based on the machine learning according to claim 3, wherein the performing model parameter learning on the target machine learning network model according to the sample learning data comprises:
performing pollutant emission prediction on the template pollutant emission data in the target machine learning data based on the first pollutant emission data in the sample learning data through the target machine learning network model to generate a pollutant emission prediction result; wherein the pollutant emission prediction result comprises a generated pollutant emission description label of the corresponding template pollutant emission data and the corresponding label-guided knowledge data; and
updating the neuron weight information of the target machine learning network model based on a loss result between the pollutant emission prediction result and the second pollutant emission data in the sample learning data, so as to perform the model parameter learning on the target machine learning network model.

5. The method for predicting the pollutant emission based on the machine learning according to claim 1, wherein the target machine learning data is one machine learning data obtained from a training data sequence, and a step of generating the training data sequence comprises:
obtaining a plurality of machine learning data of the target machine learning network model, wherein each machine learning data comprises one template pollutant emission data and a training supervision data of the corresponding template pollutant emission data, the training supervision data of any one template pollutant emission data comprises the prior pollutant emission description label of the corresponding template pollutant emission data and the corresponding label-guided knowledge data, and the prior pollutant emission description label in any one machine learning data is selected from the plurality of pollutant emission description labels;
determining a number of templates of each pollutant emission description label among the plurality of pollutant emission description labels according to the plurality of machine learning data; wherein the number of templates of any one pollutant emission description label is used to indicate the number of machine learning data in the plurality of machine learning data containing the any one pollutant emission description label;
based on the number of templates of each pollutant emission description label, determining a marginal pollutant emission description label from the plurality of pollutant emission description labels; wherein the marginal pollutant emission description label is used to indicate a pollutant emission description label corresponding to the number of templates less than a predetermined number;
extracting one or more template pollutant emission data from the template pollutant emission data contained in the machine learning data comprising the marginal pollutant emission description label;
performing feature derivation on each selected template pollutant emission data, to generate Y iteration pollutant emission data, wherein Y is a positive integer; one iteration pollutant emission data corresponds to one template pollutant emission data, and there is a consistent pollution feature path between any one iteration pollutant emission data and its corresponding template pollutant emission data;
using the training supervision data of the template pollutant emission data corresponding to each iteration pollutant emission data as the training supervision data of the corresponding iteration pollutant emission data;
using each iteration pollutant emission data as an iteration template pollutant emission data, and generating Y iteration machine learning data according to the Y iteration pollutant emission data and corresponding training supervision data; and
generating the training data sequence according to the plurality of machine learning data and the Y iteration machine learning data.

6. The method for predicting the pollutant emission based on the machine learning according to claim 5, wherein the performing feature derivation on each selected template pollutant emission data, to generate Y iteration pollutant emission data, comprises:
obtaining a feature derivation request of a feature derivation network, wherein the feature derivation request characterizes generating iteration pollutant emission data with a consistent pollution feature path for the template pollutant emission data based on input template pollutant emission data and the prior pollutant emission description label;
obtaining one or more derivative sample combination data, wherein any one derivative sample combination data comprises one sample pollutant emission data, a prior pollutant emission description label of the corresponding one sample pollutant emission data, and a pollutant emission data with a consistent pollution feature path with the corresponding one sample pollutant emission data; and
generating the iteration pollutant emission data with the consistent pollution feature path for each selected template pollutant emission data, based on the feature derivation request and the one or more derivative sample combination data through the feature derivation network, to generate the Y iteration pollutant emission data.

7. The method for predicting the pollutant emission based on the machine learning according to claim 6, wherein the generating the iteration pollutant emission data with the consistent pollution feature path for each selected template pollutant emission data, based on the feature derivation request and the one or more derivative sample combination data through the feature derivation network, to generate the Y iteration pollutant emission data, comprises:
polling each selected template pollutant emission data, and using a currently polled template pollutant emission data as a current template pollutant emission data;
generating one input pollutant emission data segment according to the current template pollutant emission data and the corresponding prior pollutant emission description label;
integrating the feature derivation request, the one or more derivative sample combination data, and the input pollutant emission data segment generated to generate a derivative learning data corresponding to the current template pollutant emission data;
generating an iteration pollutant emission data with a consistent pollution feature path with the current template pollutant emission data by learning the derivative learning data corresponding to the current template pollutant emission data through the feature derivation network; and
continuing to perform polling until all selected template pollutant emission data are polled to generate the Y iteration pollutant emission data.

8. The method for predicting the pollutant emission based on the machine learning according to claim 6, wherein the generating the iteration pollutant emission data with the consistent pollution feature path for each selected template pollutant emission data, based on the feature derivation request and the one or more derivative sample combination data through the feature derivation network, to generate the Y iteration pollutant emission data, comprises:
fusing the feature derivation request and the one or more derivative sample combination data to generate a training sample of the feature derivation network;
using each selected template pollutant emission data and a corresponding prior pollutant emission description label, to generate the input pollutant emission data segment corresponding to each template pollutant emission data;
training the feature derivation network based on the training sample to generate a trained feature derivation network; and
generating the iteration pollutant emission data with the consistent pollution feature path for the corresponding template pollutant emission data based on the input pollutant emission data segment corresponding to each template pollutant emission data through the trained feature derivation network, to generate the Y iteration pollutant emission data.

9. The method for predicting the pollutant emission based on the machine learning according to claim 1, wherein the method further comprises:
generating candidate pollutant emission data according to the model enabling definition information and the target pollutant emission data after receiving a prediction instruction for the target pollutant emission data, wherein the target pollutant emission data is configured in the candidate pollutant emission data as the input pollutant emission data; and
performing pollutant emission prediction on the target pollutant emission data based on the candidate pollutant emission data through the pollutant emission prediction model, and generating the pollutant emission description label and the corresponding label-guided knowledge data of the target pollutant emission data.

10. A system for predicting pollutant emission based on machine learning, wherein the system for predicting the pollutant emission based on the machine learning comprises a processor and a memory, the memory is connected with the processor, the memory is configured to store programs, instructions or codes, and the processor is configured to execute the programs, instructions or codes in the memory to implement the method for predicting the pollutant emission based on the machine learning according to claim 1.

11. The system for predicting the pollutant emission based on the machine learning according to claim 10, wherein the sample learning data is one pollutant emission data generated by fusing the model enabling definition information and the target machine learning data; the performing the model parameter learning on the target machine learning network model according to the sample learning data comprises:
performing feature encoding on the sample learning data to generate X encoded feature node data, wherein X is a positive integer;
based on time series information of the X encoded feature node data, generating a feature to be learned according to a top X-1 encoded feature node data in the X encoded feature node data; and generating an expected output feature corresponding to the feature to be learned according to X-1 encoded feature node data except a first encoded feature node data among the X encoded feature node data;
inferring the encoded feature node data one by one for the feature to be learned through the target machine learning network model to generate an inference result;
wherein the inference result comprises X-1 encoded feature node data that have been inferred, and an a-th encoded feature node data in the inference result is inferred based on a top a encoded feature node data in the feature to be learned, where a is a positive integer between 1 and X-1;
calculating an error parameter corresponding to each encoded feature node data in the inference result based on the expected output feature and the inference result, wherein an error parameter corresponding to the a-th encoded feature node data in the inference result characterizes a loss result between the a-th encoded feature node data in the inference result and the a-th encoded feature node data in the expected output feature;
fusing error parameters corresponding to respective encoded feature node data in the inference result to generate a training error parameter of the target machine learning network model; and
updating neuron weight information of the target machine learning network model according to a training target that minimizes the training error parameter, so as to perform the model parameter learning on the target machine learning network model.

12. The system for predicting the pollutant emission based on the machine learning according to claim 10, wherein the generating a sample learning data for updating the target machine learning network model according to the model enabling definition information and the target machine learning data comprises:
fusing the model enabling definition information and the template pollutant emission data in the target machine learning data for outputting as one pollutant emission data to generate a first pollutant emission data;
fusing the prior pollutant emission description label in the target machine learning data and the label-guided knowledge data in the target machine learning data for outputting as one pollutant emission data to generate a second pollutant emission data; and
generating the sample learning data for updating the target machine learning network model according to the first pollutant emission data and the second pollutant emission data.

13. The system for predicting the pollutant emission based on the machine learning according to claim 12, wherein the performing model parameter learning on the target machine learning network model according to the sample learning data comprises:
performing pollutant emission prediction on the template pollutant emission data in the target machine learning data based on the first pollutant emission data in the sample learning data through the target machine learning network model to generate a pollutant emission prediction result; wherein the pollutant emission prediction result comprises a generated pollutant emission description label of the corresponding template pollutant emission data and the corresponding label-guided knowledge data; and
updating the neuron weight information of the target machine learning network model based on a loss result between the pollutant emission prediction result and the second pollutant emission data in the sample learning data, so as to perform the model parameter learning on the target machine learning network model.

14. The system for predicting the pollutant emission based on the machine learning according to claim 10, wherein the target machine learning data is one machine learning data obtained from a training data sequence, and a step of generating the training data sequence comprises:
obtaining a plurality of machine learning data of the target machine learning network model, wherein each machine learning data comprises one template pollutant emission data and a training supervision data of the corresponding template pollutant emission data, the training supervision data of any one template pollutant emission data comprises the prior pollutant emission description label of the corresponding template pollutant emission data and the corresponding label-guided knowledge data, and the prior pollutant emission description label in any one machine learning data is selected from the plurality of pollutant emission description labels;
determining a number of templates of each pollutant emission description label among the plurality of pollutant emission description labels according to the plurality of machine learning data; wherein the number of templates of any one pollutant emission description label is used to indicate the number of machine learning data in the plurality of machine learning data containing the any one pollutant emission description label;
based on the number of templates of each pollutant emission description label, determining a marginal pollutant emission description label from the plurality of pollutant emission description labels; wherein the marginal pollutant emission description label is used to indicate a pollutant emission description label corresponding to the number of templates less than a predetermined number;
extracting one or more template pollutant emission data from the template pollutant emission data contained in the machine learning data comprising the marginal pollutant emission description label;
performing feature derivation on each selected template pollutant emission data, to generate Y iteration pollutant emission data, wherein Y is a positive integer; one iteration pollutant emission data corresponds to one template pollutant emission data, and there is a consistent pollution feature path between any one iteration pollutant emission data and its corresponding template pollutant emission data;
using the training supervision data of the template pollutant emission data corresponding to each iteration pollutant emission data as the training supervision data of the corresponding iteration pollutant emission data;
using each iteration pollutant emission data as an iteration template pollutant emission data, and generating Y iteration machine learning data according to the Y iteration pollutant emission data and corresponding training supervision data; and
generating the training data sequence according to the plurality of machine learning data and the Y iteration machine learning data.

15. The system for predicting the pollutant emission based on the machine learning according to claim 14, wherein the performing feature derivation on each selected template pollutant emission data, to generate Y iteration pollutant emission data, comprises:
obtaining a feature derivation request of a feature derivation network, wherein the feature derivation request characterizes generating iteration pollutant emission data with a consistent pollution feature path for the template pollutant emission data based on input template pollutant emission data and the prior pollutant emission description label;
obtaining one or more derivative sample combination data, wherein any one derivative sample combination data comprises one sample pollutant emission data, a prior pollutant emission description label of the corresponding one sample pollutant emission data, and a pollutant emission data with a consistent pollution feature path with the corresponding one sample pollutant emission data; and
generating the iteration pollutant emission data with the consistent pollution feature path for each selected template pollutant emission data, based on the feature derivation request and the one or more derivative sample combination data through the feature derivation network, to generate the Y iteration pollutant emission data.

16. The system for predicting the pollutant emission based on the machine learning according to claim 15, wherein the generating the iteration pollutant emission data with the consistent pollution feature path for each selected template pollutant emission data, based on the feature derivation request and the one or more derivative sample combination data through the feature derivation network, to generate the Y iteration pollutant emission data, comprises:
polling each selected template pollutant emission data, and using a currently polled template pollutant emission data as a current template pollutant emission data;
generating one input pollutant emission data segment according to the current template pollutant emission data and the corresponding prior pollutant emission description label;
integrating the feature derivation request, the one or more derivative sample combination data, and the input pollutant emission data segment generated to generate a derivative learning data corresponding to the current template pollutant emission data;
generating an iteration pollutant emission data with a consistent pollution feature path with the current template pollutant emission data by learning the derivative learning data corresponding to the current template pollutant emission data through the feature derivation network; and
continuing to perform polling until all selected template pollutant emission data are polled to generate the Y iteration pollutant emission data.

17. The system for predicting the pollutant emission based on the machine learning according to claim 15, wherein the generating the iteration pollutant emission data with the consistent pollution feature path for each selected template pollutant emission data, based on the feature derivation request and the one or more derivative sample combination data through the feature derivation network, to generate the Y iteration pollutant emission data, comprises:
fusing the feature derivation request and the one or more derivative sample combination data to generate a training sample of the feature derivation network;
using each selected template pollutant emission data and a corresponding prior pollutant emission description label, to generate the input pollutant emission data segment corresponding to each template pollutant emission data;
training the feature derivation network based on the training sample to generate a trained feature derivation network; and
generating the iteration pollutant emission data with the consistent pollution feature path for the corresponding template pollutant emission data based on the input pollutant emission data segment corresponding to each template pollutant emission data through the trained feature derivation network, to generate the Y iteration pollutant emission data.

18. The system for predicting the pollutant emission based on the machine learning according to claim 10, wherein the method further comprises:
generating candidate pollutant emission data according to the model enabling definition information and the target pollutant emission data after receiving a prediction instruction for the target pollutant emission data, wherein the target pollutant emission data is configured in the candidate pollutant emission data as the input pollutant emission data; and
performing pollutant emission prediction on the target pollutant emission data based on the candidate pollutant emission data through the pollutant emission prediction model, and generating the pollutant emission description label and the corresponding label-guided knowledge data of the target pollutant emission data.
